(19) United States
(12) Patent Application Publication
(10) Pub. No.: US 2002/0021813 A1
(43) Pub. Date: Feb. 21, 2002

(54) Optical microphone

(76) Inventors: Masahiko Moriguchi, Tottori-shi (JP); Tetsuro Inoue, Tottori-shi (JP); Alexander Paritsky, Modiin (IL); Alexander Kots, Ashdod (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/798,506

(22) Filed: Mar. 2, 2001

(30) Foreign Application Priority Data
Aug. 19, 1998 (JP) 10-232548

(51) Int. Cl. H04R 25/00

(52) U.S. Cl. 381/172

(57) ABSTRACT

An optical microphone in which the difference between the sum of the thickness of a light emission element mounting substrate 3 and the height of a light emission element 1 and the sum of the thickness of a light-receiving element mounting substrate 4 and the height of a light-receiving element 2 is made smaller than the difference between the height of the light emission element 1 and the height of the light-receiving element 2. The optical path is thereby reduced, and the intensity of the light reaching the light-receiving element is increased, changes in the output of the light-receiving element caused by the vibration of the membrane film are increased, and the sensitivity of the microphone is increased. It is preferable that the sum of the thickness of the light emission element mounting substrate 3 and the height of the light emission element 1 and the sum of the thickness of a light-receiving element mounting substrate 4 and the height of the light-receiving element 2 are equal.

### BACKGROUND OF THE INVENTION

1. Field of the Invention

The microphone of the present invention is applied to a field of small type microphones used for car telephones, mobile phones or the like, and a field of intruder detection utilizing a pressure change due to the intruder.

2. Description of the Related Art

FIG. 2 shows a conceptual view of a conventional optical microphone. This optical microphone is constructed such that a light emission element 1 and a light-receiving element 2 mounted on substrates 3, 4 are sealed with a transparent resin 10, and an optically nontransparent film 7 is disposed between the light emission element and the light-receiving element within the sealed portion. An optically nontransparent film 7 is formed in an area other than areas serving as a light exit 8 and a light entrance 9 on the outer surface of the transparent resin-sealing portion. Above the light exit 8 and the light entrance 9, a photo-reflective membrane film 6 that vibrates due to sound, pressure or the like is held by a membrane support 5. The light from the light emission element 1 is emitted via the light exit 8, reflected by the membrane film 6 and reaches the light-receiving element 2 via the light entrance 9. When the membrane film position is shifted due to the vibration, the reflection position also moves, and the output of the light-receiving element is changed. Sound, pressure or the like is detected by reading this output. This is the principle of the optical microphone.

As is described in Japanese Patent Application No. Hei 10-107427, the optically nontransparent film between the light emission element and the light-receiving element is prepared by a method comprising: a step of sealing a light emission element and a light-receiving element mounted on a substrate with a transparent resin, and cutting the sealed portion together with the substrate; a step of forming an optically nontransparent film on at least one of the cut faces; and a step of bonding and integrating the cut faces of the sealed portion of the light emission element and the sealed portion of the light-receiving element. Since the formed face is exposed, film formation on the cut face is easy by a method such as application or deposition, and a film without any defect can be formed. By this method, a problem of occurrence of the bias component that is not due to vibrations of the membrane film, but because the light from the light emission element directly reaches the light-receiving element can be solved.

Moreover, the light exit and the light entrance are prepared by a method in which the upper part of a resin sealing portion is made plane, a polygonal cylindrical or columnar protruding portion is provided within this plane, and an optically nontransparent film is formed on the whole face of the outer surface of the transparent resin sealing portion by a method such as application or deposition, and then polished. By this method, even if there is an error in the polished quantity, the area of the light exit and the light entrance does not change, and hence the product stability is high in the incident light quantity into the membrane film and in the light-receiving element reaching light quantity in the light reflected by the membrane film.

In general, as the light emission element 1, a near infrared light emitting diode is used, and as the light-receiving element 2, a near infrared photodiode or phototransistor is used. The reason why near infrared wavelength is selected is that it is not expensive, and that visible radiation outdoor daylight is not made to be a backlight. The light emitting diode is prepared on a GaAs compound semiconductor substrate, and the photodiode and phototransistor are prepared on a Si substrate.

With the light emission element 1 and the light-receiving element 2, since the substrate materials therefor are different, the height of the element is different in many cases. The electrodes on the back faces of the light emission element and the light-receiving element are die-bonded by an electroconductive adhesive or the like on the respective mounting substrates 3, 4. The surface electrode disposed on a part of a region on the surface and the mounting substrates 3, 4 are wire bonded with a bonding wire 11 such as gold wire. Even if the height of the elements is different, the substrates 3, 4, on which the light emission element and the light-receiving element are mounted, having the same thickness are heretofore used. Since the height required for wire bonding is generally 0.3 mm, the height from the substrates 3, 4, on which the light emission element and the light-receiving element are mounted, to the light exit 8 and the light entrance 9 of the resin sealing portion is decided according to an element having the highest height. Moreover, the gap between the membrane film 6 and the light exit 8 of the resin sealing portion is about several tens microns. Therefore, the optical path length along which the light emitted by the light emission element reaches the light-receiving element can be considered to be almost a distance within the resin sealing portion, and the light propagates a distance that is the sum of a double value of the height required for wire bonding and the difference in the height of the light emission element and the light- receiving element.

When the height of the light emission element and the light-receiving element is different, the conventional optical microphone has a defect of low sensitivity. The intensity of the light emitted by the light emitting diode is inversely proportional to the square of propagation distance due to the expanse of light. With the conventional optical microphone, since the light also propagates in the optical path resulting from the difference in the height of the light emission element and the light-receiving element, the optical path length is long and the intensity of the light reaching the light-receiving element is low. Accordingly, changes in the output of the light-receiving element resulting from the vibration of the membrane film are also small, and the sensitivity of the microphone is low. It is, therefore, an object of the present invention to solve the technical problem of low sensitivity of the microphone.

### SUMMARY OF THE INVENTION

When the height of the light emission element and the light-receiving element is different, the difference between the sum of the thickness of a light emission element mounting substrate and the height of the light emission element and the sum of the thickness of a light-receiving element mounting substrate and the height of the light-receiving element is made smaller than the difference between the height of the light emission element and the height of the light-receiving element. Thereby, the optical path resulting from the difference in the height of the light emission element and the light-receiving element is reduced, the optical path length is made short, the intensity of the light reaching the light-receiving element is increased, changes in the output of the light-receiving element caused by the vibration of the membrane film are made large, and the sensitivity of the microphone is increased. Moreover, the sum of the thickness of a light emission element mounting substrate and the height of the light emission element and the sum of the thickness of a light-receiving element mounting substrate and the height of the light-receiving element are made equal.

### BRIEF DESCRIPTION OF THE DRAWINGS

FIG. 1 shows an embodiment of an optical microphone of the present invention.

FIG. 2 shows a conventional optical microphone.

In the above figures, reference symbol 1 denotes a light emission element, 2 denotes a light-receiving element 3 denotes a light emission element mounting substrate, 4 denotes a light-receiving element mounting substrate, 5 denotes a membrane support, 6 denotes a membrane film, 7 denotes an optically nontransparent film, 8 denotes a light exit, 9 denotes a light entrance, 10 denotes a transparent resin, and 11 denotes a bonding wire.

### DESCRIPTION OF THE SPECIFIC EMBODIMENTS

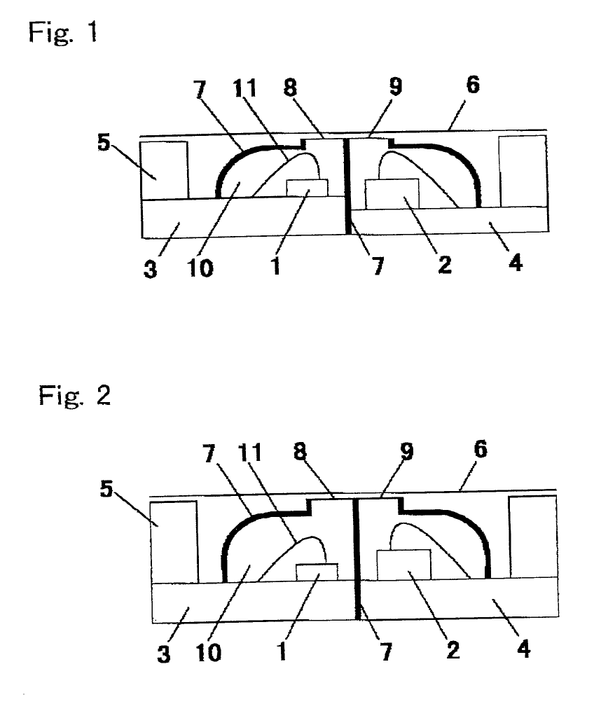

FIG. 1 shows an embodiment of the present invention. This optical microphone has a construction such that a light emission element 1 and a light-receiving element 2 mounted on substrates 3, 4 are sealed with a transparent resin 10, and an optically nontransparent film 7 is disposed between the light emission element and the light-receiving element within the sealed portion. An optically nontransparent film 7 is formed in an area other than the area serving as a light exit 8 and a light entrance 9 on the outer surface of the transparent resin-sealing portion. Above the light exit 8 and the light entrance 9, a photo-reflective membrane film 6 which vibrates due to sound, pressure or the like is held by a membrane support 5. The light from the light emission element 1 is emitted via the light exit 8, reflected by the membrane film 6 and reaches the light-receiving element 2 via the light entrance 9. When the membrane position is shifted due to the vibration, the reflection position also moves, to thereby change the output of the light-receiving element. Sound, pressure or the like is detected by reading this output.

When the height of the light emission element and the light-receiving element is different, the difference between the sum of the thickness of a light emission element mounting substrate 3 and the height of the light emission element 1 and the sum of the thickness of a light-receiving element 4 mounting substrate and the height of the light-receiving element 2 is made smaller than the difference between the height of the light emission element 1 and the height of the light-receiving element 2. In the example shown in FIG. 1, since the height of the light-receiving element 2 is higher than the height of the light emission element 1, the thickness of the light-receiving element mounting substrate 4 is made thinner than the thickness of the light emission element mounting substrate 3. Also, as shown in FIG. 1, it is desired to set the thickness of each mounting substrate so that the sum of the thickness of the light emission element mounting substrate 3 and the height of the light emission element 1 and the sum of the thickness of the light-receiving element mounting substrate 4 and the height of the light-receiving element 2 are made equal.

Then, after the electrodes on the surface and the back surface of the light emission element 1 and the light-receiving element 2 and the respective mounting substrates 3, 4 are die-bonded and wire-bonded, these are sealed with the transparent resin 10. Thereafter, the sealed portion is cut together with the substrate, and the optically nontransparent film 7 is formed on at least one of the cut faces, and the cut faces are bonded and integrated. Since the mounting substrates are bonded again after having been cut, it is easy to use ones in which the thickness of the light emission element mounting substrate 3 and the thickness of the light-receiving element mounting substrate 4 is different.

Moreover, the upper part of a transparent resin-sealing portion is made plane, and a polygonal cylindrical or columnar protruding portion is provided within this plane. After the optically nontransparent film 7 is formed on the whole face of the outer surface of the resin sealing portion, the film is polished, to thereby prepare the light exit 8 and the light entrance 9. According to the present invention, the optical path resulting from the difference in the height of the light emission element and the light-receiving element is reduced, the optical path length is made short, the intensity of the light reaching the light-receiving element is increased, and changes in the output of the light-receiving element caused by the vibration of the membrane film are made large.

More specifically, the height of an element of a general near infrared light emitting diode is 0.2 mm, and the height of the near infrared photodiode and the phototransistor is 0.3 mm. The height required for bonding is generally 0.3 mm. By using these values, conventionally, the height from the light emission element to the light exit in the resin sealing portion is 0.4 mm, and the height between the light entrance in the resin sealing portion and the light-receiving element is 0.3 mm. According to the present invention, if a light emission element mounting substrate thicker than the light-receiving element mounting substrate by 0.1 mm is used, the both sides become 0.3 mm, respectively, thereby the vertical distance is reduced to 86%.

As described above, the intensity of the light emitted by the light emitting diode is inversely proportional to the square of propagation distance. When the propagation distance becomes 86%, the intensity of light reaching the light-receiving element is increased by 36%, and hence great increase can be achieved according to the present invention. In this embodiment, the height of the light emission element is lower than that of the light-receiving element, but it is obvious that the present invention is also effective in an example wherein the height of the light emission element is higher than that of the light-receiving element.

As described above, according to the present invention, the optical path resulting from the difference in the height of the light emission element and the light-receiving element is reduced, the optical path length is made short, the intensity of the light reaching the light-receiving element is increased, changes in the output of the light-receiving element caused by the vibration of the membrane film are made large, and the sensitivity of the microphone is increased.

What is claimed is:

1. An optical microphone having a light emission element and a light-receiving element, whose height is different, built therein, wherein the difference between the sum of the thickness of a light emission element mounting substrate and the height of a light emission element and the sum of the thickness of a light-receiving element mounting substrate and the height of a light-receiving element is made smaller than the difference between the height of the light emission element and the height of the light-receiving element.

2. An optical microphone having a light emission element and a light-receiving element, whose height is different, built therein, wherein the sum of the thickness of a light emission element mounting substrate and the height of a light emission element and the sum of the thickness of a light-receiving element mounting substrate and the height of a light-receiving element are made equal.
